(19) United States
(12) Patent Application Publication
(10) Pub. No.: US 2026/0269557 A1
(43) Pub. Date: Sep. 10, 2026

(54) TOTAL REFLECTION SLAB LASER AMPLIFIER

(71) Applicant: Xiamen Unit Electronic and Technology Company Ltd., Xiamen (CN)

(72) Inventors: WENJUN LIU, Xiamen (CN); QI LIU, Xiamen (CN); KUI LI, Xiamen (CN); LI XU, Xiamen (CN); JING ZHANG, Xiamen (CN)

(21) Appl. No.: 19/073,296

(22) Filed: Mar. 7, 2025

(51) Int. Cl. H01S 3/10; H01S 3/139

(52) U.S. Cl. CPC H01S 3/1003; H01S 3/139

(57) ABSTRACT

A total reflection slab laser amplifier is provided, which includes a main body, a surface of the main body is fixedly provided with a total reflection film, a right side of the main body is fixedly provided with a connecting line, the surface of the main body is penetrated with a bolt, and the bolt is threaded connected in an installation base, when the bolt is loose, the loosed bolt will move up inside a fixed rod, a fixed plate and a push plate will slide upward through a sliding rod, and when the push plate is slid upward, the connecting plate will move to a surface close to a toothed plate, so that an insertion plate on a surface of the connecting plate can be inserted and limit the surface of the toothed plate to prevent the bolt from loosening.

### TECHNICAL FIELD

The present disclosure relates to the field of slab laser amplifier technologies, and in particular, to a total reflection slab laser amplifier.

### BACKGROUND

The total reflection slab laser amplifier is a kind of solid laser amplifier, which plays an important role in the generation of high-power and high-quality laser beams. There is an initial, relatively weak seed laser beam entering the laser medium from the specific incidence plane of the slab. The seed laser has specific frequency, phase, polarization and other characteristics, and it enters the laser medium that is already in the state of particle number inversion, becoming the “source” of subsequent amplification. After the amplification process in the slab laser medium, the laser is output from the exit plane of the slab.

However, when the existing total reflection slab laser amplifier is used, it usually needs to be firmly connected with the equipment installation base to ensure that each component can maintain a relatively stable position relationship during operation, and ensure the accuracy of the laser light path and the stability of the overall performance. At present, the commonly used connection way is to use bolts for fixation. Although this connection method is simple and widely used, there is a more prominent problem, that is, as the equipment operates for a long time, the long-term vibration generated by the equipment will make the bolts easy to loosen. The loose bolts will damage the connection stability between the total reflection slab laser amplifier and the equipment installation base, thereby causing relative displacements between the components, which will affect the internal care designed laser light path. Besides, loose bolts can also cause excessive friction, collisions, and unreasonable stress between components, affecting the ability of laser amplifiers and connected equipment installation bases to work in relatively good mechanical condition for a long time, thereby reducing the service life of the entire equipment system.

### SUMMARY

In view of shortcomings of the prior art, the present disclosure provides a total reflection slab laser amplifier, which solves problems that when the total reflection slab laser amplifier is connected with an equipment installation base by bolts, connection bolts are loose due to the vibration conduction caused by the equipment's long-term use.

To achieve the above purpose, the present disclosure provides the following technical solutions: a total reflection slab laser amplifier, including a main body provided on a top of an installation base, where a surface of the main body is fixedly provided with a total reflection film, a right side of the main body is fixedly provided with a connection line, a surface of the main body is penetrated with a bolt, and the bolt is threaded connected inside the installation base;
where the total reflection slab laser amplifier further includes:
an active component, configured to prevent the main body from loosening after being connected by the bolt;
a fixing component, configured to tighten the bolt after loosening;
a movable component, configured to improve a connection stability of the bolt;
where the active component includes a fixed column fixedly provided in the installation base, a fixed rod fixedly provided in the fixed column, a sliding rod slidably connected in the fixed rod, the bolt threaded connected in the sliding rod, a fixing plate fixedly provided on an outer side of the sliding rod, a connection plate hinged on a surface of the fixing plate, a push plate hinged on a surface of the connection plate, and a cross block provided on a surface of the push plate; where the cross block is fixedly provided on a surface of the fixed rod, and the push plate is slidably connected in the cross block; an insertion plate is fixedly provided on an outer side of the push plate, and an interior of the fixed column is fixedly provided with a toothed plate.

In some embodiments of the present disclosure, the fixing component includes a fixing ring, the fixing ring is fixedly provided on a surface of the sliding rod, the sliding rod is sleeved on a surface of the bolt, an outer side of the fixing ring is fixedly provided with a connection block, an interior of the connection block is hinged with a first movable ball, a top of the first movable ball is fixedly provided with a long rod, and a top of the long rod is fixedly provided with a second movable ball.

In some embodiments of the present disclosure, an interior of the installation base is rotatably connected with a swivel ring, the second movable ball is hinged in the swivel ring, an interior of the swivel ring is slidably connected with a positioning shaft, and the positioning shaft is fixedly provided on an inner wall of the installation base, the positioning shaft is rotationally connected with a torsion block, and the torsion block is threaded connected on the surface of the bolt.

In some embodiments of the present disclosure, the movable component includes a rotating shaft fixedly provided at a bottom of the torsion block, a sliding rod slidably connected to a surface of the rotating shaft, and a collision shaft fixedly provided on the surface of the sliding rod.

In some embodiments of the present disclosure, an interior of the collision shaft is slidably connected with a short rod, and the short rod is fixedly provided at a bottom of the positioning shaft.

In some embodiments of the present disclosure, the surface of the fixed rod is provided with a chute, and a surface of the cross block is provided with a recess.

In some embodiments of the present disclosure, a circular groove is provided on a surface of the connection block, and a circular groove is provided in the swivel ring.

In some embodiments of the present disclosure, a surface of the positioning shaft is provided with a strip-shaped groove, and the surface of the rotating shaft is provided with an arc groove.

In some embodiments of the present disclosure, there are four tooth plates, and the four tooth plates are arranged in a circumferential array with a center point of the fixed column as a center.

Compared with the prior art, the present disclosure provides a total reflection slab laser amplifier, which has the following beneficial effects.
1. This total reflection slab laser amplifier uses the setting of active component. When the bolt connecting the main body and the installation base is loose, the loose bolt will move up inside the fixed rod, thus driving the fixing plate and the push plate to slide upward through the sliding rod. When the push plate slides upward, it will drive the connection plate to move to the surface close to the toothed plate, so that the insertion plate on the surface of the connection plate will be inserted on the surface of the toothed plate for limit, to prevent the bolt from loosening due to a long-term operation of the equipment, so as to ensure the connection stability between the total reflection slab laser amplifier and the equipment installation base, ensure the stability of the optical path, and extend the service life of the equipment.
2. This total reflection slab laser amplifier uses the setting of fixing component, and the upward moving of the sliding rod will also drive the connection block and the first movable ball to move upward. The upward moving first movable ball will drive the second movable ball through the long rod and abut against the inside of the swivel ring, so that the swivel ring will rotate under the abutting against the second movable ball. The rotation of the swivel ring will also drive the torsion block to rotate on the surface of the upward loose bolt, so as to tighten the loose bolt. As a key connecting part, if the bolt 8 becomes loose and is not addressed in time, it may lead to relative displacements between parts, loose connections, and other issues, thereby damaging the structural stability of the entire equipment. This solution can address the problem of bolt loosening in real time, ensuring that the parts always maintain a stable connection state, improving the connection stability between the main body and the equipment structure, and enhancing the accuracy of the optical path.
3. This total reflection slab laser amplifier uses the setting of movable component when the torsion block is rotated, it will also drive the rotating shaft to rotate, when the rotating shaft is rotated, it will drive the sliding rod and the collision shaft to slide downward on the surface of the short rod, so that the collision shaft will abut against the top of the sliding rod that slides upward, and limit the rising sliding rod, prevent the sliding rod from excessive sliding upward when driven by loose bolts, and improve the stability and fixing effect of the total reflection slab laser amplifier in use.

### BRIEF DESCRIPTION OF DRAWINGS

FIG. 1 is a front view structure diagram of a total reflection slab laser amplifier proposed by the present disclosure.

FIG. 2 is a side view structure diagram of the total reflection slab laser amplifier proposed by the present disclosure.

FIG. 3 is a sectional structure diagram of an installation base of the total reflection slab laser amplifier proposed by the present disclosure.

FIG. 4 is a front section view structure diagram of a fixed column of the total reflection slab laser amplifier proposed by the present disclosure.

FIG. 5 is a front view structure diagram of an active component of the total reflection slab laser amplifier proposed by the present disclosure.

FIG. 6 is a front view structure diagram of a fixed rod of the total reflection slab laser amplifier proposed by the present disclosure.

FIG. 7 is a front view structure diagram of a fixing component of the total reflection slab laser amplifier proposed by the present disclosure.

FIG. 8 is a schematic diagram of a bottom structure of a positioning shaft of the total reflection slab laser amplifier proposed by the present disclosure.

FIG. 9 is a front view structure diagram of a movable component of the total reflection slab laser amplifier proposed by the present disclosure.

Numeral reference: 1—installation base; 2—main body; 3—total reflection film; 4—connection line; 5—active component; 51—fixed column; 52—fixed rod; 53—sliding rod; 54—fixing plate; 55—connection plate; 56—cross block; 57—insertion plate; 58—toothed plate; 59—push plate; 6—fixing component; 61—fixing ring; 62—connection block; 63—first movable ball; 64—long rod; 65—swivel ring; 66—positioning shaft; 67—torsion block; 68—second movable ball; 7—movable component; 71—rotating shaft; 72—sliding rod; 73—collision shaft; 74 short rod; 520—chute; 560—recess; 620—circular groove; 650—circular groove; 660—strip—shaped groove; 710—arc groove; 8—bolt.

### DESCRIPTION OF EMBODIMENTS

Below, the technical solutions in the embodiments of the present disclosure will be clearly and completely described in combination with the accompanying drawings. Obviously, the described embodiments are only a part of the embodiments of the present disclosure, not all of them. Based on the embodiments of the present disclosure, all other embodiments obtained by those skilled in the art without creative work are within the protection scope of the present disclosure.

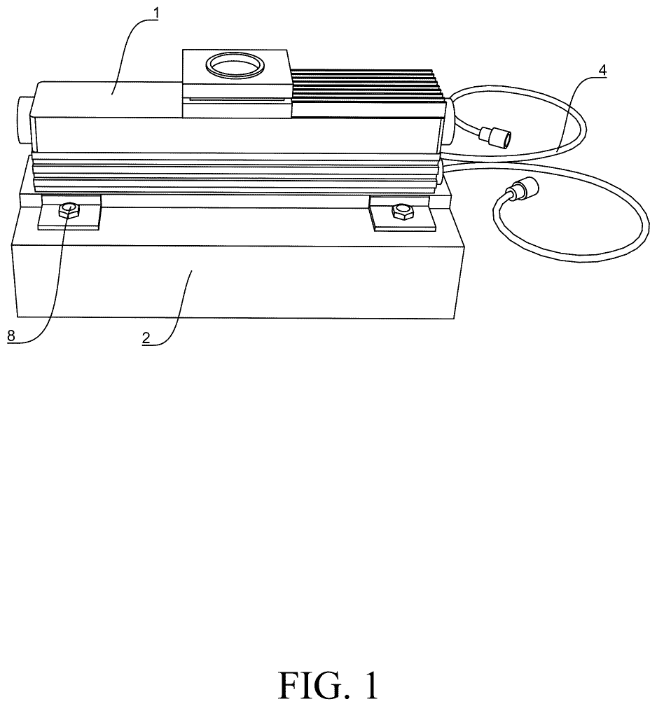

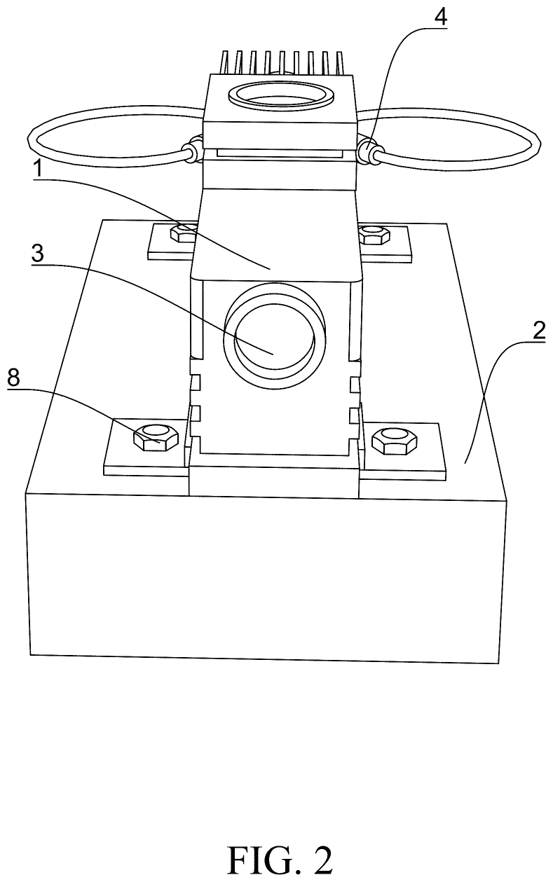

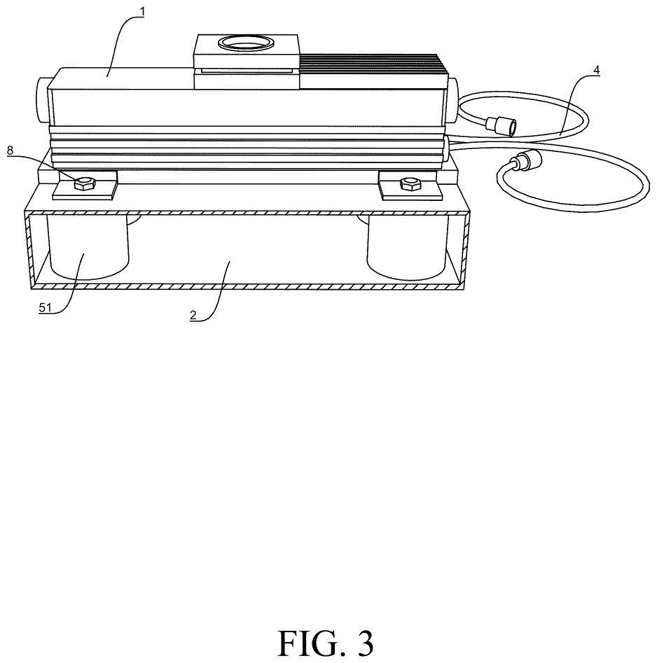

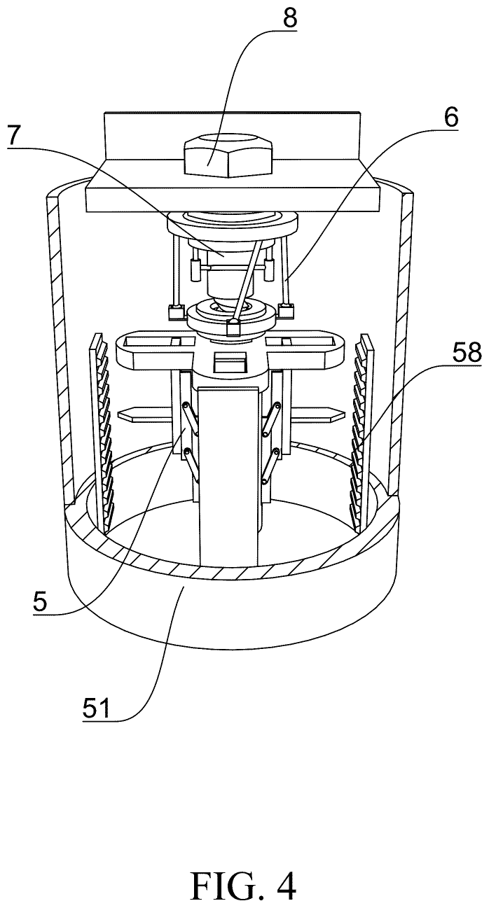

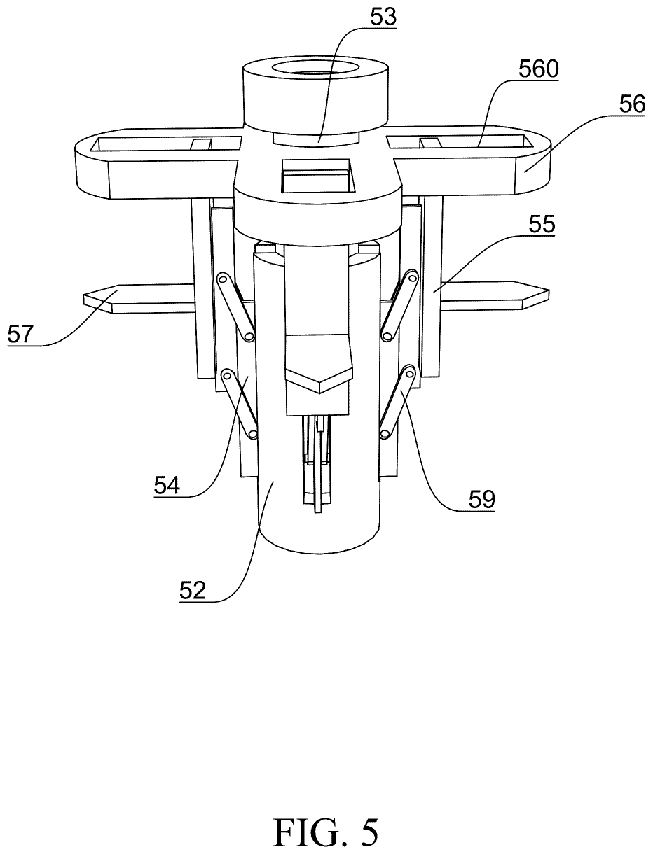

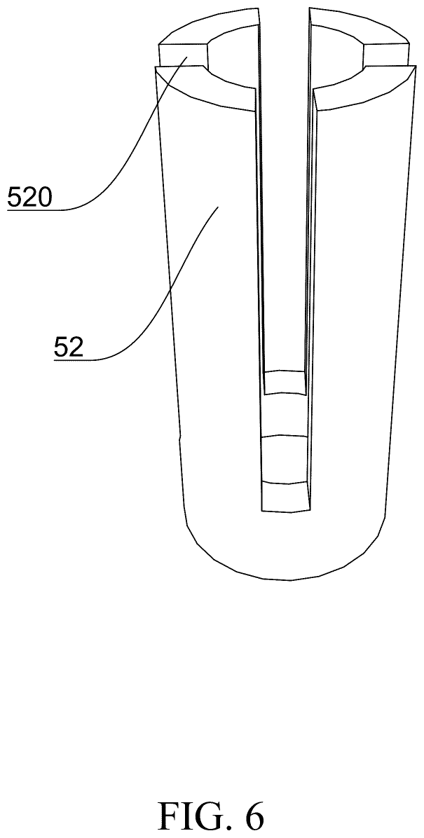

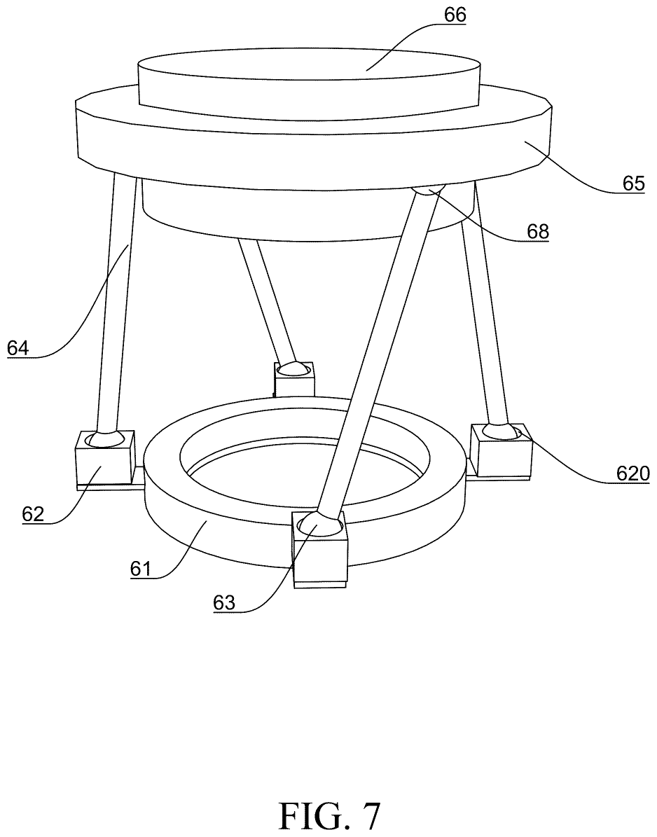

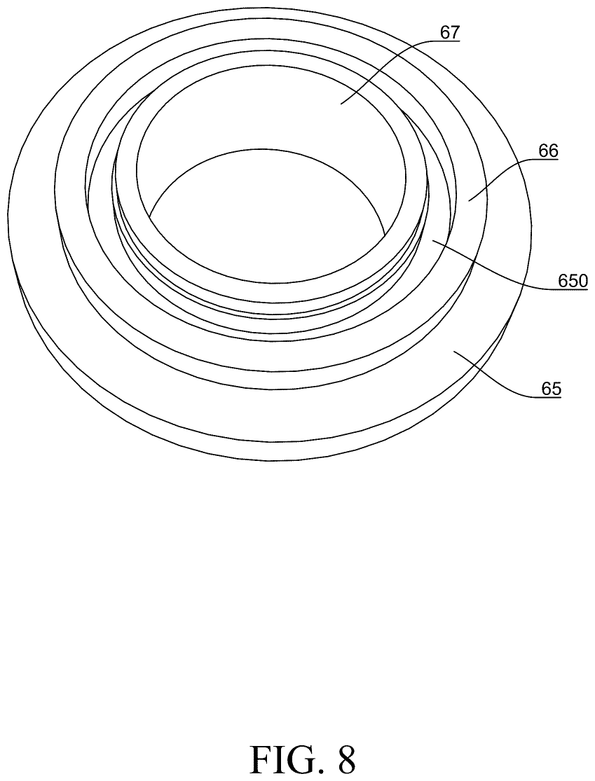

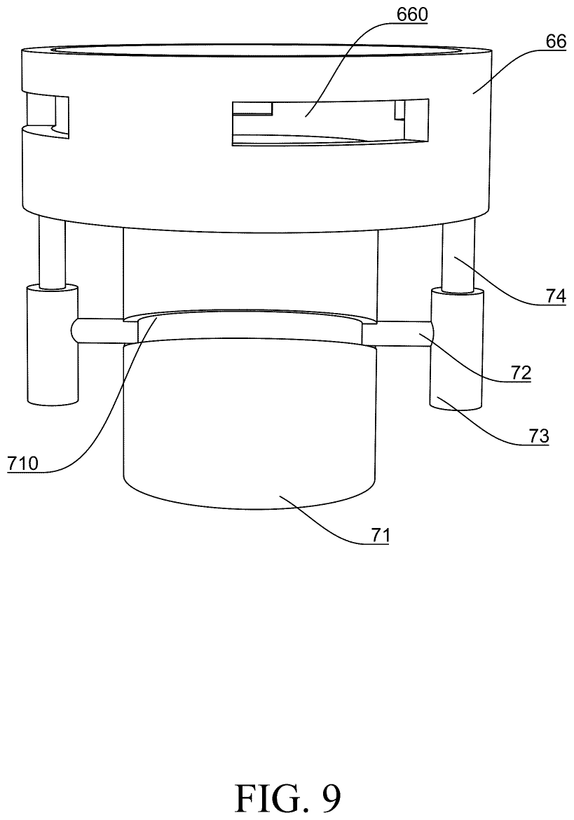

Refer to FIGS. 1-9, a total reflection slab laser amplifier, including a main body 2 provided on a top of an installation base 1, a surface of the main body 2 is fixedly provided with a total reflection film 3, which can achieve a total reflection effect of the slab laser amplifier through the total reflection film 3 on the surface of the main body 2, a right side of the main body 2 is fixedly provided with a connection line 4, the surface of the main body 2 is penetrated with a bolt 8, and the bolt 8 is threaded connected inside the installation base 1;
the total reflection slab laser amplifier further includes an active component 5, which is configured to prevent the main body 2 from loosening after being connected by the bolt 8;
a fixing component 6, configured to tighten the bolt 8 after loosening;
a movable component 7, configured to improve a connection stability of the bolt 8;
the active component 5 includes a fixed column 51 fixedly provided in the installation base 1, a fixed rod 52 fixedly provided in the fixed column 51, a sliding rod 53 slidably connected in the fixed rod 52, the bolt 8 threaded connected inside the sliding rod 53, and a fixing plate 54 fixedly provided on an outer side of the sliding rod 53. A surface of the fixing plate 54 is hinged with a connection plate 55, and a surface of the connection plate 55 is hinged with a push plate 59. The push plate 59 is provided with a cross block 56 on a surface of the push plate 59. The cross block 56 is in a cross shape, which allows the connection plate 55 to slide outward inside the cross block 56, thereby achieving a smooth sliding of an insertion plate 57. The cross block 56 is fixedly provided on a surface of the fixed rod 52, and the push plate 59 is slidably connected in the cross block 56; an outer side of the push plate 59 is fixedly provided with the insertion plate 57, and an interior of the fixed column 51 is fixedly provided with a toothed plate 58. A loosed bolt 8 will drive the fixing plate 54 and the push plate 59 through the sliding rod 53 to slide upwards and abut against with connection plate 55 by the push plate 59; the insertion plate 57 on the surface of the connection plate 55 is caused to be inserted into the surface of toothed plate 58 for limiting, thereby preventing the bolt 8 from loosening due to a prolonged operation of the equipment, ensuring a stable optical path, and extending the service life of the equipment.

The fixing component 6 includes a fixing ring 61, which is fixedly provided on a surface of the sliding rod 53, and the sliding rod 53 is sleeved on a surface of the bolt 8. A connection block 62 is fixedly provided on an outer side of the fixing ring 61, and a first movable ball 63 is hinged in the connection block 62. A long rod 64 is fixedly provided on a top of the first movable ball 63, and a second movable ball 68 is fixedly provided on a top of the long rod 64. An interior of the installation base 1 is rotatably connected to a swivel ring 65, and the second movable ball 68 is hinged in the swivel ring 65. An interior of the swivel ring 65 is slidably connected to a positioning shaft 66, and the positioning shaft 66 is fixedly provided on an inner wall of the installation base 1. The positioning shaft 66 is rotatably connected to a torsion block 67, and the torsion block 67 is threaded connected on the surface of the bolt 8. The second movable ball 68 abuts against the interior of the swivel ring 65 through the long rod 64. Due to an inclined state of the long rod 64 when it abuts against and rises by the first movable ball 63, for this reason, the second movable ball 68 abuts against the interior of the swivel ring 65 by the long rod 64, so that the long rod 64 abutting against the second movable ball 64 can cause the second movable ball 68 contact the swivel ring 65 and drive the torsion block 67 to rotate, thereby tightening the loosen bolt 8 and responding to the problem of the bolt 8 loosening in real time, thereby improving the connection stability of between the main body 2 and the equipment structure.

In an implementation mode, the movable component 7 includes a rotating shaft 71, and the rotating shaft 71 is fixedly provided at a bottom of the torsion block 67, a sliding rod 72 is slidably connected on a surface of the rotating shaft 71, a collision shaft 73 is fixedly provided on the surface of the sliding rod 72, a rotation of the torsion block 67 will drive a rotation of the rotating shaft 71, and when the rotating shaft 71 is rotated, it will drive the collision shaft 73 at a bottom of the sliding rod 72 to abut against a top of the sliding rod 53 and limit it, so as to improve the stability and fixation effect of the total reflection slab laser amplifier in use. The short rod 74 is slidably connected in the collision shaft 73, and the short rod 74 is fixedly provided at a bottom of the positioning shaft 66. The collision shaft 73 can be driven to slide down by the short rod 74 when the rotating shaft 71 is rotated.

In an implementation mode, the surface of the fixed rod 52 is provided with a chut 520, and the chute 520 provided on the surface of the fixed rod 52 can be used to connect the sliding rod 53 with the fixing plate 54. Therefore, when the sliding rod 53 is raised, it will also drive the fixing plate 54 to move upward on an outer wall of the fixed rod 52. A surface of the cross block 56 is provided with a recess 560, the recess 560 provided on the surface of the cross block 56 can be used to slide the connection plate 55 inside the cross block 56. A surface of the connection block 62 is provided with a circular groove 620, and the circular groove 620 provided on the surface of the connection block 62 can be used to rotate the first movable ball 63 inside the connection block 62. The swivel ring 65 is provided with a circular groove 650, and the circular groove 650 provided in the swivel ring 65 can be used to achieve an increase in movement range of the second movable ball 68 and the long rod 64, a strip-shaped groove 660 is provided on a surface of the positioning shaft 66. The strip-shaped groove 660 provided on the surface of the positioning shaft 66 can be used to connect the swivel ring 65 with the torsion block 67 inside the positioning shaft 66, and drive the positioning shaft 66 to rotate when the swivel ring 65 is rotated. The surface of the rotating shaft 71 is provided with an arc groove 710, and the arc groove 710 provided on the surface of the rotating shaft 71 can be used to drive the sliding rod 72 to slide downward during a rotation of the rotating shaft 71.

In an implementation mode, there are four toothed plates 58, and all four toothed plates 58 are arranged in a circular array with a center point of the fixed column 51 as a center. A uniform insertion of the insertion plate 57 can be achieved by limiting the moving insertion plate 57 through the four toothed plates 58.

To sum up, when the total reflection slab laser amplifier is used, after the seed light is emitted from a seed light component, it is incident into a gain medium through a first window surface of the gain medium. Under an action of pump light, particles in the gain medium realize an inversion of the particle number. Under the stimulation of the seed light, the particles at the high level generate stimulated radiation, so that the seed light is amplified. Under the action of each reflective surface of the gain medium and the reflector module, the amplified light is reflected multiple times in the gain medium, and is continuously amplified. Finally, it is emitted into the amplified laser through the first window surface or the second window surface. The total reflection film 3 affixed on the surface of the main body 2 enables the main body to achieve a total reflection effect. Before use, the total reflective flat surface laser amplifier needs to be firmly connected to the equipment installation base 1. The connection method usually involves using bolt 8. When the bolt 8 loosens due to vibration transmission caused by long-term operation of the equipment, the bolt 8 will move upward inside the fixed column 51. When the bolt 8 moves, it will drive the sliding rod 53 to slide upward inside the fixed rod 52. When the sliding rod 53 slides upward, it will drive the fixing plate 54 connected to the outside to move upward. When the fixing plate 54 moves upward, it will move closer to the inner wall of the fixed column 51 inside the cross block 56 by the push plate 59 abutting against the connection plate 55. When the connection plate 55 is moved, it will drive the insertion plate 57 to move in the same way as the connection plate 55, so that the insertion plate 57 can be inserted into fixed column 51. The surface of the toothed plate 58 limits an upward movement of the bolt 8 to prevent it from loosening due to prolonged operation of the equipment, so as to ensure the connection stability between the total reflection slab laser amplifier and the equipment installation base 1, ensure a stability of optical path, and extend the service life of the equipment.

When the sliding rod 53 slides upwards, it also drives the fixing ring 61 on the surface of the sliding rod 53 to move upwards. When the fixing ring 61 moves upwards, it drives the connection block 62 and the first movable ball 63 hinged inside the connection block 62 to move upwards. When the first movable ball 63 moves upwards, it drives the second movable ball 68 through the inclined long rod 64 and collides with the inside of the swivel ring 65, the swivel ring 65 is caused to rotate under the contact of the second movable ball 68. When the swivel ring 65 is rotated, it drives the torsion block 67 to rotate. When the torsion block 67 is rotated, it tightens the loose bolt 8, thereby preventing the bolt 8 from loosening at the connection due to a long-term equipment operation. After the bolt 8 continues to slide, the connection is completely dispersed, and the bolt 8 is a key connecting component. If it becomes loose and cannot be dealt with in a timely manner, it may lead to relative displacement and loose connections between the components, disrupting the structural stability of the entire device. By setting the fixing component 6, the problem of the bolt 8 loosening can be dealt with in real time, ensuring that each component always maintains a stable connection state, improving the connection stability between the main body 2 and the device structure, and enhancing the accuracy of the optical path.

When the torsion block 67 is rotated, it will also drive the rotating shaft 71 to rotate. When the rotating shaft 71 is rotated, it will drive the sliding rod 72 on the surface 1 to slide downward through the arc groove 710 provided on the surface of the rotating shaft 7. When the sliding rod 72 slides downward, it will cause the collision shaft 73 on the surface of the sliding rod 72 to slide downward on the surface of the short rod 74, thus making the collision shaft 73 to against the top of the sliding rod 53 that slides upward, so as to limit the sliding rod 53, prevent the sliding rod 53 from excessive sliding upward when driven by the loose bolt 8, and improve the stability and fixing effect of the total reflection slab laser amplifier in use.

It should be noted that in this specification, relational terms such as first and second are only used to distinguish one entity or operation from another, and do not necessarily require or imply any actual relationship or order between these entities or operations. Furthermore, the terms “including”, “comprising”, or any other variation thereof are intended to cover a non-exclusive inclusion. This means that a process, method, item, or device comprising a series of elements includes not only those elements but also other elements not explicitly listed or elements inherent to such process, method, item, or device. Without further limitations, the element defined by the statement “including one . . . ” does not exclude the existence of other identical elements in the process, method, item, or device that includes the element in question.

What is claimed is:

1. A total reflection slab laser amplifier, comprising a main body provided on a top of an installation base,
wherein a surface of the main body is fixedly provided with a total reflection film, a right side of the main body is fixedly provided with a connection line, a surface of the main body is penetrated with a bolt, and the bolt is threaded connected inside the installation base;
wherein the total reflection slab laser amplifier further comprises:
an active component, configured to prevent the main body from loosening after being connected by the bolt;
a fixing component, configured to tighten the bolt after loosening;
a movable component, configured to improve a connection stability of the bolt;
wherein the active component comprises a fixed column fixedly provided in the installation base, a fixed rod fixedly provided in the fixed column, a sliding rod slidably connected in the fixed rod, the bolt threaded connected in the sliding rod, a fixing plate fixedly provided on an outer side of the sliding rod, a connection plate hinged on a surface of the fixing plate, a push plate hinged on a surface of the connection plate, and a cross block provided on a surface of the push plate;
wherein the cross block is fixedly provided on a surface of the fixed rod, and the push plate is slidably connected in the cross block;
an insertion plate is fixedly provided on an outer side of the push plate, and an interior of the fixed column is fixedly provided with a toothed plate.

2. The total reflection slab laser amplifier according to claim 1, wherein the fixing component comprises a fixing ring, the fixing ring is fixedly provided on a surface of the sliding rod, the sliding rod is sleeved on a surface of the bolt, an outer side of the fixing ring is fixedly provided with a connection block, an interior of the connection block is hinged with a first movable ball,
a top of the first movable ball is fixedly provided with a long rod, and a top of the long rod is fixedly provided with a second movable ball.

3. The total reflection slab laser amplifier according to claim 1, wherein an interior of the installation base is rotatably connected with a swivel ring, the second movable ball is hinged in the swivel ring,
an interior of the swivel ring is slidably connected with a positioning shaft, and the positioning shaft is fixedly provided on an inner wall of the installation base,
the positioning shaft is rotationally connected with a torsion block, and the torsion block is threaded connected on the surface of the bolt.

4. The total reflection slab laser amplifier according to claim 1, wherein the movable component comprises a rotating shaft fixedly provided at a bottom of the torsion block, a sliding rod slidably connected to a surface of the rotating shaft, and a collision shaft fixedly provided on the surface of the sliding rod.

5. The total reflection slab laser amplifier according to claim 1, wherein an interior of the collision shaft is slidably connected with a short rod, and the short rod is fixedly provided at a bottom of the positioning shaft.

6. The total reflection slab laser amplifier according to claim 1, wherein the surface of the fixed rod is provided with a chute, and a surface of the cross block is provided with a recess.

7. The total reflection slab laser amplifier according to claim 3, wherein a circular groove is provided on a surface of the connection block, and a circular groove is provided in the swivel ring.

8. The total reflection slab laser amplifier according to claim 4, wherein a surface of the positioning shaft is provided with a strip-shaped groove, and the surface of the rotating shaft is provided with an arc groove.

9. The total reflection slab laser amplifier according to claim 1, wherein there are four tooth plates, and the four tooth plates are arranged in a circumferential array with a center point of the fixed column as a center.
